(19) United States
(12) Patent Application Publication
(10) Pub. No.: US 2020/0331036 A1
(43) Pub. Date: Oct. 22, 2020

(54) WASHER

(71) Applicant: Jenfab Cleaning Solutions, Springfield, MO (US)

(72) Inventors: Hadley Keith McHaffie, Willard, MO (US); Travis Gardner, Ozark, MO (US); Brian Bykowski, Republic, MO (US)

(21) Appl. No.: 16/722,655

(22) Filed: Dec. 20, 2019

Related U.S. Application Data
(60) Provisional application No. 62/836,983, filed on Apr. 22, 2019.

(51) Int. Cl. B08B 3/04; B08B 3/10

(52) U.S. Cl. CPC B08B 3/045; B08B 2203/007; B08B 3/102

(57) ABSTRACT

A parts washer for washing parts includes a housing defining an interior that receives the parts. The interior includes a washing fluid reservoir to hold a washing fluid, the washing fluid reservoir having a washing fluid fill level. A soak basket receives the parts and is disposed in the washing fluid reservoir such that at least a portion of the soak basket is disposed below the washing fluid fill level for soaking the parts when the reservoir is filled with washing fluid. A part support platform is in the interior of the housing. The part support platform has a part support surface for supporting some of the parts thereon. The part support surface is above the washing fluid fill level. A washing system washes the parts on the part support surface.

### CROSS-REFERENCE TO RELATED APPLICATIONS

This application claims the benefit of U.S. Provisional Application No. 62/836,983, filed Apr. 22, 2019, the entirety of which is hereby incorporated by reference.

### FIELD

The present disclosure generally relates to systems and methods for cleaning and washing, and, more specifically, to a washer for washing parts received therein.

### BACKGROUND

A parts washer is a washer that cleans various parts including, but not limited to machinery and machine parts. Parts washers use a washing fluid (e.g., cleaning solution) to remove contaminants such as grease, carbon, resins, tar, inks, dirt and other grime from dirty parts like engine parts, tools, etc.

### SUMMARY

In one aspect, a parts washer for washing parts comprises a housing defining an interior configured to receive the parts therein. The interior includes a washing fluid reservoir configured to hold a washing fluid. The washing fluid reservoir has a washing fluid fill level. A soak basket is sized and shaped to receive one or more of the parts. The soak basket is disposed in the washing fluid reservoir such that at least a portion of the soak basket is disposed below the washing fluid fill level for soaking the one or more parts received in the soak basket in the washing fluid when the reservoir is filled with washing fluid at least up to the washing fluid fill level. A part support platform is in the interior of the housing. The part support platform has a part support surface configured to receive one or more of the parts thereon. The part support surface is above the washing fluid fill level. A washing system is configured to wash the one or more parts on the part support surface.

A method of cleaning a part comprises positioning a part to be cleaned in a soak basket in pooled washing fluid in a washing fluid reservoir of a parts washer, permitting the part in the pooled washing fluid to soak in the pooled washing fluid, before or after permitting the part to soak in the pooled washing fluid, supporting the part with a part support surface of a part support platform in the parts washer above the pooled washing fluid, and washing the part while supported by the part support surface.

Other objects and features will be in part apparent and in part pointed out hereinafter.

### BRIEF DESCRIPTION OF THE DRAWINGS

FIG. 1 is a perspective of a washer according to one embodiment of the present disclosure with a door of the washer in an open position;

FIG. 2 is a front perspective looking into an interior of the washer of FIG. 1;

FIG. 3 is right side view of the washer of FIG. 1;

FIG. 4 is an enlarged, fragmentary right side view of the washer;

FIG. 5 is a rear perspective of the washer of FIG. 1;

FIG. 6 is a front view of the washer of FIG. 1;

FIG. 7 is a cross section taken through line 7-7 of FIG. 1;

FIG. 8 is a cross section taken through line 8-8 of FIG. 3;

FIG. 9 is a front perspective looking into the interior of the washer of FIG. 1 with a support platform removed from the washer;

FIG. 10 is a perspective of a soak basket according to one embodiment of the present disclosure;

FIG. 11 is a perspective of the washer of FIG. 1 with the door in the closed position; and

FIG. 12 is a cross section taken through line 12-12 of FIG. 11.

Corresponding reference characters indicate corresponding parts throughout the drawings.

### DETAILED DESCRIPTION

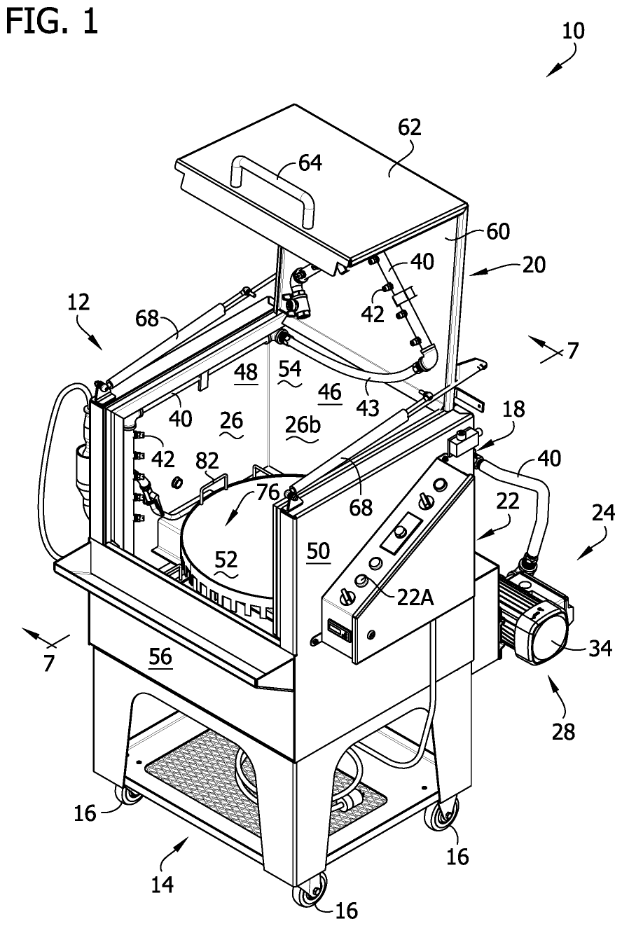

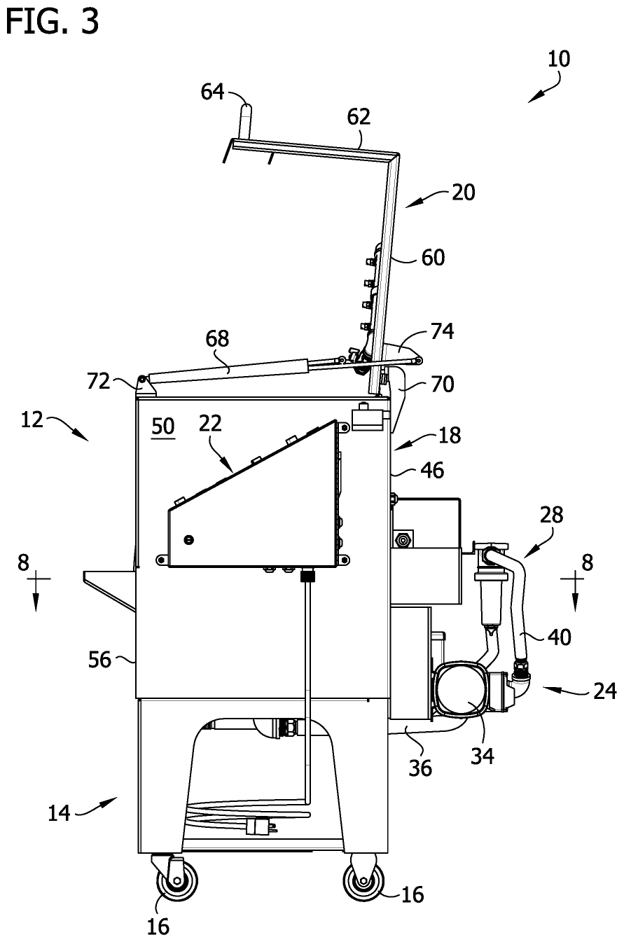

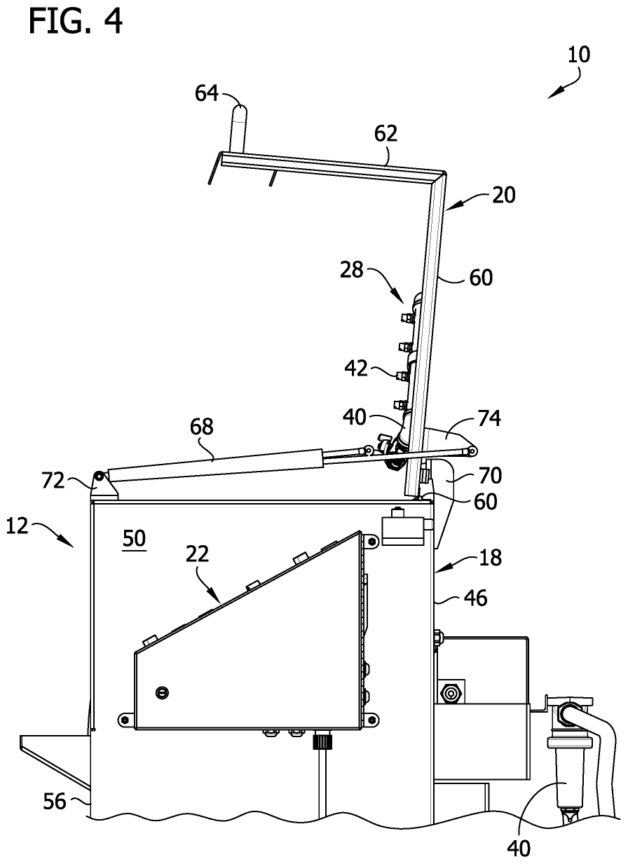

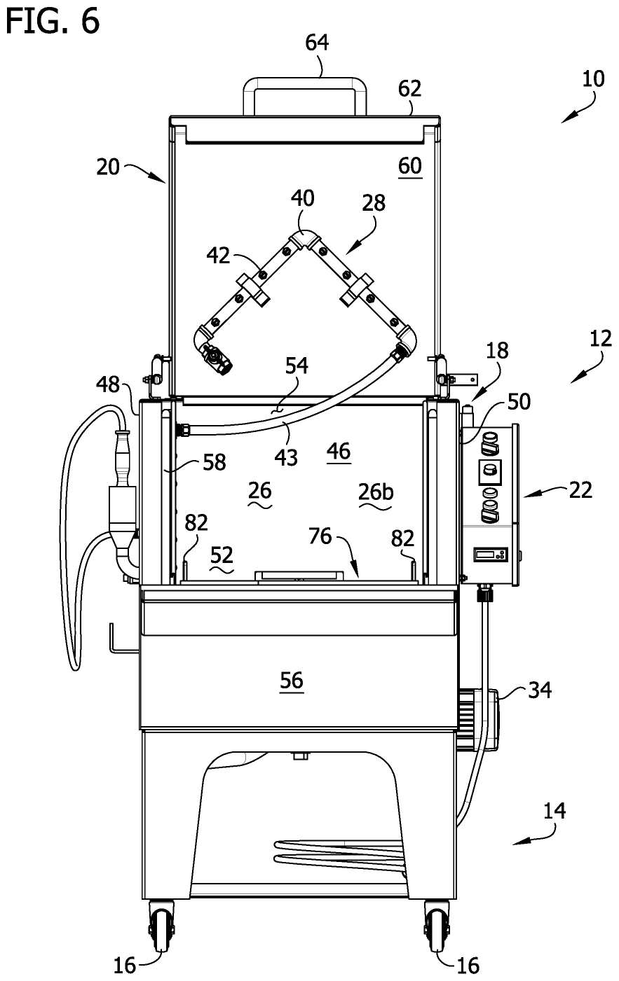

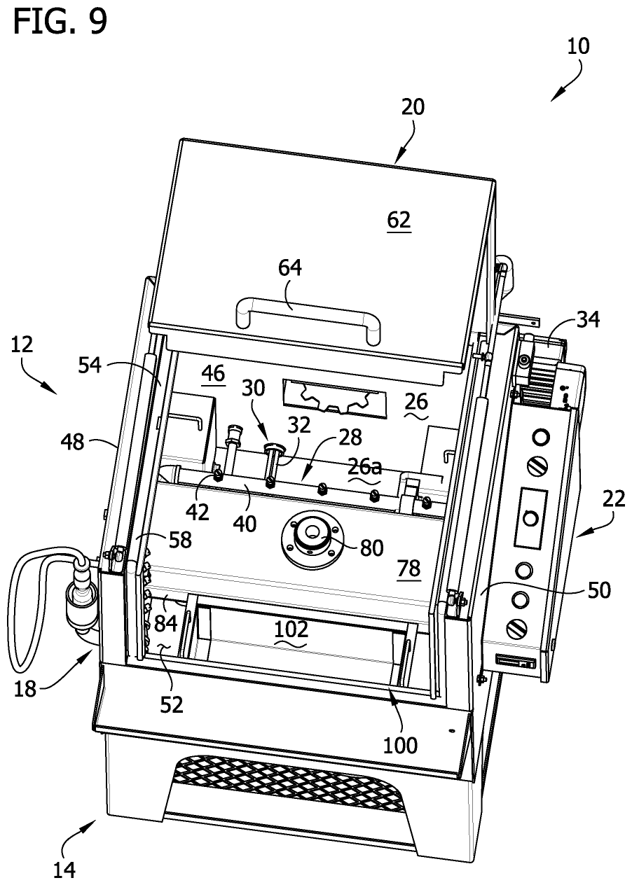

Referring to FIGS. 1-12, one embodiment of a washer (broadly, a cleaning system) is generally indicated at reference numeral 10. The washer 10 cleans parts (items, components, or articles, etc.) with a washing fluid such as water, water with a detergent or soap, or another fluid (e.g., including solvent). For example, the washer 10 may be an industrial or commercial parts washer, although it is understood the teachings herein can be applied to other types of washers.

In the illustrated embodiment, the washer 10 includes a cabinet 12 and a base 14 (e.g., stand) supporting the cabinet. The base 14 includes a plurality of casters 16 to enable the washer to be easily moved. The cabinet 12 includes a housing 18, a hatch or door 20, a control panel 22 and a washing system, generally indicated at 24. The housing 18 defines an interior 26 sized and shaped to receive one or more parts therein to be cleaned. The washing system 24 is configured to wash or clean the one or more parts placed (e.g., received) in the interior 26, as described in more detail below. The interior 26 includes a lower portion or reservoir 26a and an upper portion 26b. The lower portion 26a of the interior 26 is configured to hold at least a portion of the washing fluid. The control panel 22 controls the operation of the washer 10, specifically the washing system 24, and includes a user interface having inputs (e.g., buttons) and a display to interact with an operator and allow the operator to control the operation of the washer.

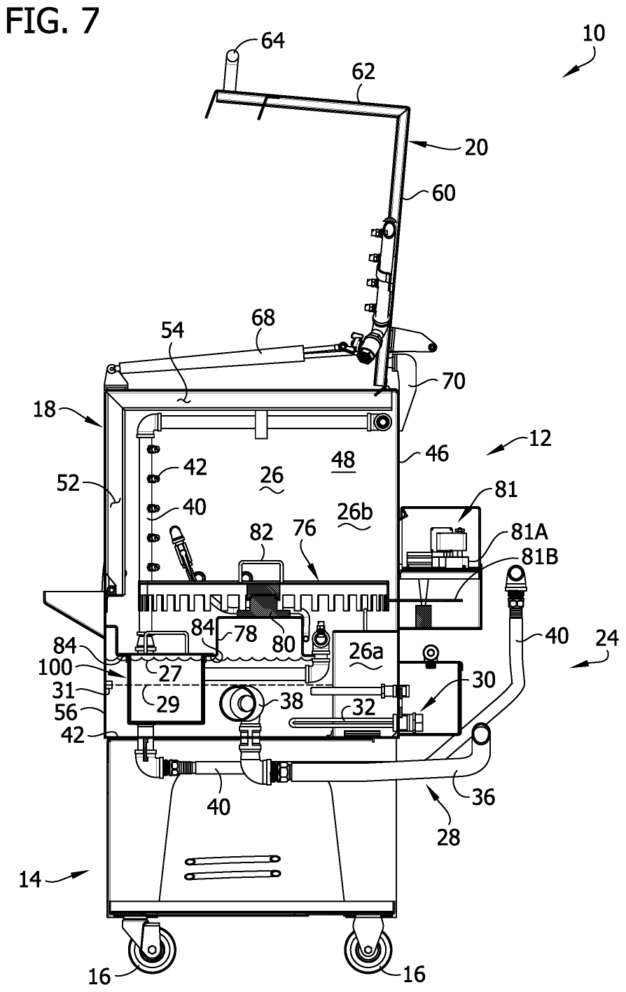

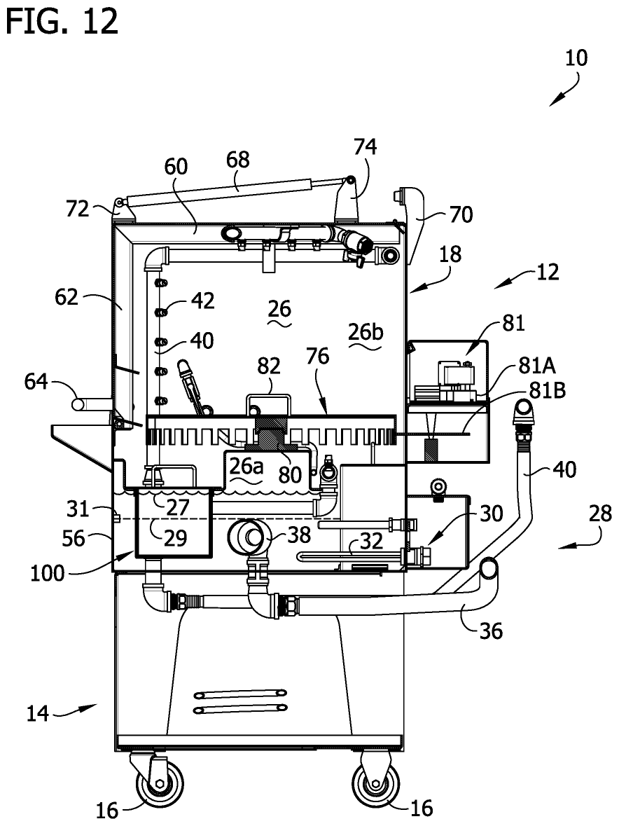

The washing fluid pools in the reservoir 26a and is heated and moved by the washing system 24 to wash the parts in the washer 10. The washing fluid reservoir 26a has a washing fluid fill level to which or above which washing fluid is to be filled in the reservoir for operation of the parts washer. An example high washing fluid fill level is indicated at 27 in FIGS. 7 and 12. An example low washing fluid fill level is indicated at 29. Desirably, the washing fluid is filled at least as high as the low washing fluid fill level 29 and more desirably to about the high washing fluid fill level 27. In the illustrated embodiment, the low washing fluid fill level 29 is monitored by a float sensor 31 (FIG. 12). If the washing fluid is below the low washing fluid fill level, the float sensor 31 signals the control panel 22, which causes a low washing fluid alarm light 22A to illuminate. The float sensor 31 can be referred to broadly as a washing fluid level indicator that monitors a preset washing fluid fill level, which in the illustrated embodiment is the low washing fluid fill level. Other indicators (e.g., markings, indicia, etc.) can be used. It will be appreciated that a similar indicator can be provided in addition to or as an alternative to the float sensor 31 to monitor the high washing fluid fill level 29. The preset washing fluid fill level corresponds to a preset vertical level or height (or range of acceptable values) to which or above which the washing fluid should be filled in the reservoir. Other types of washing fluid fill levels could be used without departing from the scope of the present disclosure. The washing fluid fill level indicator could be an electronic fill level sensor that detects the level of water in the interior and/or directly or indirectly opens and closes a fill valve based on an indication from the indicator to selectively add washing fluid to the reservoir 26a. The washing fluid fill level indicator could also be a mechanical float valve that provides a visual and/or electronic signal (indication) to inform a user of the attained desired fill level and/or directly or indirectly closes the fill valve based on an indication from the indicator to stop adding washing fluid to the reservoir 26a. It will be appreciated that overfilling the reservoir 26a would result in longer time required to heat the washing fluid and underfilling the reservoir could result in insufficient washing fluid to properly run the washing system 24.

The washing system 24 is configured to wash the one or more parts received in the interior 18 of the housing 18. The washing system 24 includes a washing fluid circulation system, generally indicated at 28, configured to circulate (e.g., move) the washing fluid within the interior 26 of the housing and a heating system, generally indicated at 30, configured to heat the washing fluid. The heating system 30 can heat the washing fluid when the washing fluid is stationary or being moved by the washing fluid circulation system 28. In the illustrated embodiment, the heating system 30 includes an electric resistance heating element 32 (broadly “heat source”). Other ways of heating the washing fluid are within the scope of the present disclosure, such as a gas heating system. The electrically resistive heating element 32 is disposed in the lower portion 26a of the interior 26 to heat the washing fluid contained therein.

The fluid circulation system 28 includes a pump 34 (e.g., including an electric motor) configured to move the washing fluid, return pipes 36, a strainer 38, supply pipes 40, and a plurality of nozzles 42 (broadly, the return pipes, strainer, supply pipes and nozzles are “plumbing”). The strainer 38 is disposed in the lower portion 26a of the interior 26. The strainer 38 covers an inlet (e.g., a washing fluid inlet) of the plumbing that receives washing fluid from the reservoir 26a. The return pipes 36 are connected to the strainer 38 and the pump 34 and carry the washing fluid from the lower portion 26a of the interior 26 to the pump 34. The supply pipes 40 are connected to the nozzles 42 and the pump 34 and carry the washing fluid from the pump to the nozzles. The nozzles 42 are disposed in both the upper and lower portions 26b, 26a of the interior 26 and each nozzle defines a circulation outlet that sprays the washing fluid into the interior to wash and clean the one or more part received in the interior. As shown, the nozzles 42 are spread out in the interior 26 including some of the nozzles 42 being on the door 20. A length of pipe 40 is mounted on the inner surface of the door 20 and is movable conjointly with the door. As shown in FIGS. 1, 2, and 6, the plumbing can include a length of flexible tubing 43 to connect to the pipe mounted on the inner surface of the door. It will be appreciated that the flexible tubing 43 serves as a flexible plumbing joint that permits movement of the door without requiring a disconnection of the plumbing. Other articulating plumbing joints (e.g., rigid swivel joints) and/or flexible plumbing joints can be used without departing from the scope of the present disclosure.

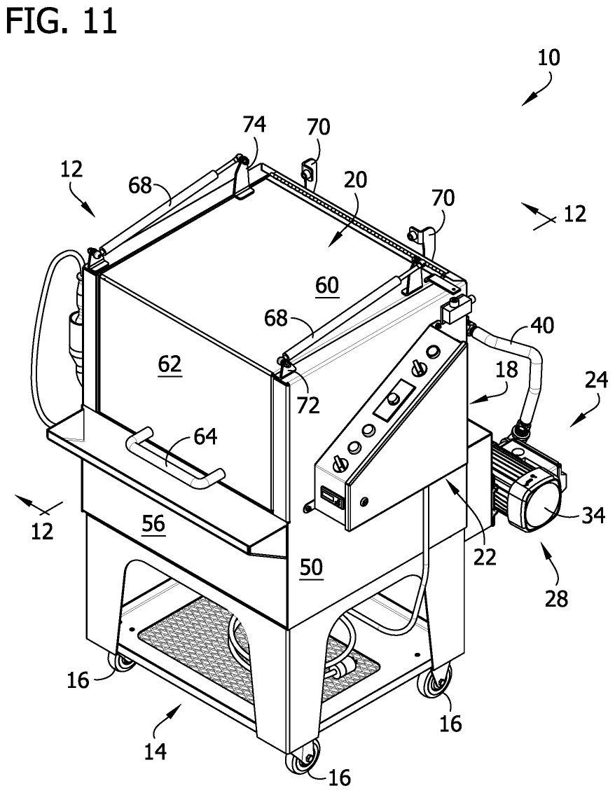

The housing 18 has a bottom wall or panel 44 (FIG. 7), a rear wall 46 extending upward from the bottom wall (specifically, a rear edge margin thereof), and opposite left and right side walls 48 and 50, respectively, extending upward from the bottom wall (specifically, opposite left and right edge margins thereof) in front of the rear wall. The rear wall 46 is connected to and extends between the left and right side walls 48, 50 (specifically, rear edge margins thereof). The bottom, rear, left side and right side walls 44, 46, 48, 50 at least partially define the interior 26 of the housing 18. The housing 18 has (e.g., defines) a front opening 52 for accessing the interior 26. The housing 18 also has (e.g., defines) a top opening 54 for accessing the interior 26. The door 20 is configured to move between a closed position (FIG. 11) in which the door closes both the front and top openings 52, 54 to inhibit access to the interior 26 of the housing 18 and an open position (FIG. 1) in which the door permits access to the interior 26 through the front and top openings. As used throughout the present disclosure, the terms defining relative locations and positions of structures and components, including but not limited to “top,” “bottom,” “front,” “rear,” “left,” and “right” are meant to provide a point of reference for such components and structures as shown in FIG. 1, with the understanding that the respective locations of such components and structures will depend on the orientation of the washer.

The rear, left side and right side walls 46, 48, 50 all extend upward from the bottom wall 44 to an upper edge margin. The upper edge margins of the rear, left side and right side walls 46, 48, 50 are all generally co-planar. The upper edge margins of the rear, left side and right side walls 46, 48, 50 generally define at least a portion of the top opening 54. The housing 18 may also include a front wall 56 extending upward from the bottom wall 44 (specifically, a front edge margin thereof) to an upper edge margin. The front wall 56 is connected to and extends between the left and right side walls 48, 50 (specifically, front edge margins thereof). The upper edge margin of the front wall 56 is disposed below the upper edge margins of the rear, left side and right side walls 46, 48, 50. In other words, the front wall 46 extends upward less than the height of the housing 18, such as about half the height of the housing, or less than half the height of the housing. Generally, a plane that extends through the interior 26 and is parallel to the bottom wall 44 and coextensive with the upper edge margin (or a slightly lower) of the front wall divides the interior into the lower and upper portions 26a, 26b. The upper edge margin of the front wall 56 and portions (specifically, upper portions) of the front edge margins of the left and right side walls 48, 50 define the at least a portion of the front opening 52.

In the illustrated embodiment, the front and top openings 52, 54 combine to define a door opening that is opened and closed by the door 20. The upper end of the front opening 52 is continuous with the front end of the top opening 54. In other words, the front opening 52 extends continuously to the top opening 54 without intervening structure interrupting the door opening. The front opening 52 extends downward from a front-upper edge margin of the housing toward the bottom wall 44, and the top opening extends rearward from the front-upper edge margin of the housing toward the rear wall 46. The front-upper edge margin of the housing 18 is generally defined by an imaginary line that extends between the corners defined by the front and upper edge margins of the left and right side walls 48, 50. In the illustrated embodiment, the top opening 54 extends generally the entire width and depth of the housing 18. Similarly, the front opening 52 extends generally the entire width of the housing 18 and is less than the height of the housing, such as about half the height of the housing or greater than half the height of the housing.

Accordingly, the top opening 54 has a rear end defined by the rear wall 46 (specifically, upper edge margin thereof), opposite left and right sides defined by the left and right side walls 48, 50 (specifically the upper edge margins thereof) and an unbounded or open front end. Similarly, the front opening 52 has a bottom end defined by the front wall 56 (specifically, upper edge margin thereof), opposite left and right sides defined by the left and right side walls 48, 50 (specifically, the front edge margins thereof) and an unbounded or open top end generally coextensive with the unbounded front end of the top opening 54. It is understood that other configurations of the front and top openings are within the scope of the present disclosure. For example, the housing may include a top wall defining at least a portion of the top opening such that the top opening does not extend the entire width and/or depth of the housing. The door opening including the front and top openings 52, 54 as shown and described herein generally enables easier access to the interior 26 by providing space in both the front and top of the housing to place parts in the interior 26 to be cleaned and to remove parts from the interior after the parts have been cleaned.

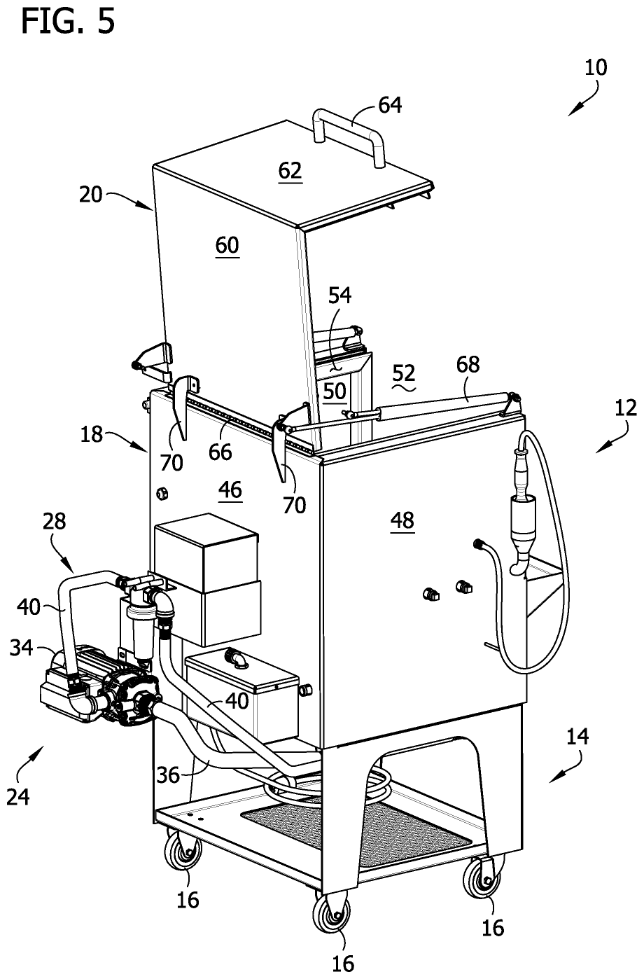

The door 20 includes a top wall 60 and a front wall 62 extending downward from the top wall (specifically, a front edge margin thereof). A handle 64 is connected to the front wall 62. The door 20 is sized and shaped to close the door opening. Specifically, the front wall 62 of the door is sized and shaped to close the front opening 52 and the top wall 60 is sized and shaped to close the top opening 54. In other words, rear, left side and right side portions (e.g., edge margins) of the top wall 60 generally overlie the rear end and left and right sides of the top opening 54 to close the top opening. Similarly, bottom, left side and right side portion (e.g., edge margins) of the front wall 62 generally overlie the bottom end and left and right sides of the front opening 52 to close the front opening. In the closed position, the corner defined by the intersection of the top and front walls 60, 62 closes the upper end of the front opening 52 and front end of the top opening 54. The top wall 60 (specifically, a rear edge margin thereof) is connected to the housing 18 (specifically, the rear wall 46) with a hinge 66 (FIG. 5).

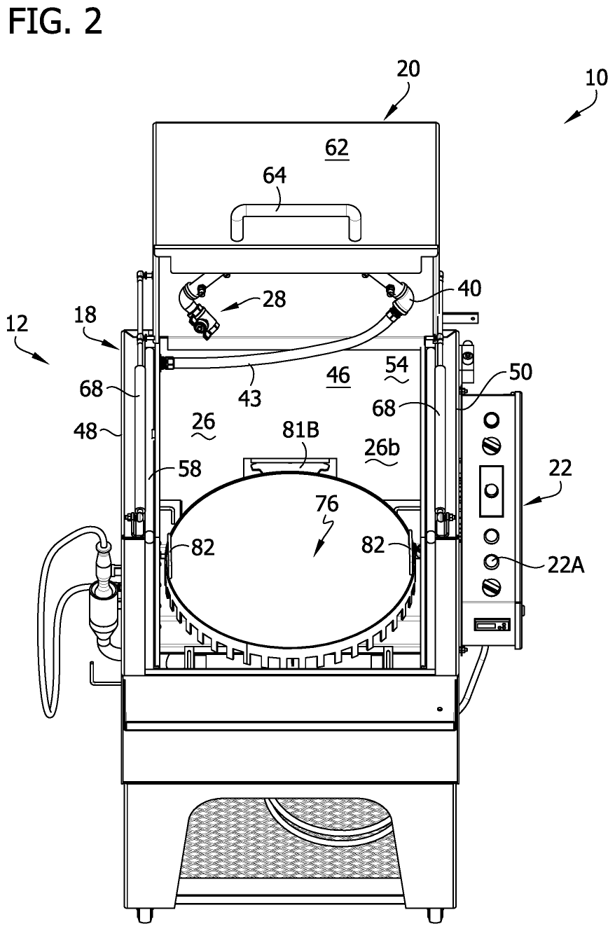

The cabinet 12 includes a gasket 58 (FIG. 2) configured to form a fluid tight seal between the door 20 and the housing 18 when the door is in the closed position. This way, washing fluid is prevented from escaping the interior 26 by leaking between the door 20 and housing 20 as the washer 10 is operating (e.g., as the fluid circulation system 24 is running and spraying washing fluid to clean the parts in the interior). In the illustrated embodiment, the gasket 58 is mounted on the housing 18. Specifically, the gasket 58 is disposed in a groove defined by the housing 18. In other embodiments, the gasket may be mounted on the door 18 (e.g., disposed in a groove defined by the door). The gasket 58 extends around the entire or most of door opening. In the illustrated embodiment, the gasket 58 extends along the left and right sides of the top opening 54, along the left and right sides of the front opening 52 and along the bottom end of the front opening. To seal or inhibit the washing fluid from leaking between rear wall 46 and the door 20, the top wall 60 of the door includes a lip that overlaps with a portion of the rear wall when the door is in the closed position to prevent any washing fluid from escaping. A gasket can be provided on the rear wall and/or the lip to facilitate forming a seal at the overlap of the rear wall and lip.

The door 20 includes at least one piston 68 (broadly, “biasing element”) configured to maintain the door in at least one of the open and closed positions. In the illustrated embodiment, the door 20 includes two pistons 68 disposed on the left and right sides of the door. Desirably, the pistons are configured to maintain the door in the opened position. The pistons 68 are resiliently biased in their extended positions, as generally shown in FIG. 1. In other words, the pistons 68 are biased to extend and resist being retracted (e.g., having their length shortened). Accordingly, the pistons 68 are biased to extend (e.g., increase in length) to hold or maintain the door 20 in the open position (as the piston resists the retraction that would have to occur when the door is moved from the opened position to the closed position). The pistons can be any suitable type of piston, such as gas pistons, or spring pistons, etc. Other types of biasing elements could be used.

To move the door 20 to the opened position, the operator grasps the handle 64 and applies enough force to overcome the force of gravity on the door. The pistons 68 assist in lifting the door and maintain it in the opened position. To close the door, the user grasps the handle 64 and applies enough force to retract the pistons and permits the door to lower to the closed position. Each piston 68 is attached to brackets at either end, with one bracket 72 connected to the housing 18 and the other bracket 74 connected to the door 20 (specifically the top panel 60). The housing 20 includes two stops 70 that engage the door in the open position. The stops 70 engage the door 20 and prevent the door from over opening (e.g., rotating).

Other ways, of maintaining the door in the opened and closed positions are within the scope of the present disclosure. For example, the pistons 68 can be used to hold the door in the open position and a latch (broadly, latch mechanism) can be used to hold the door in the closed position. In another example, the pistons 68 can be used to hold the door 20 in the open position and closed position. For example, the pistons could be configured in an over-center arrangement with respect to the pivot axis of the door with respect to the housing such that the pistons apply force to not only maintain the door open but also to maintain the door closed.

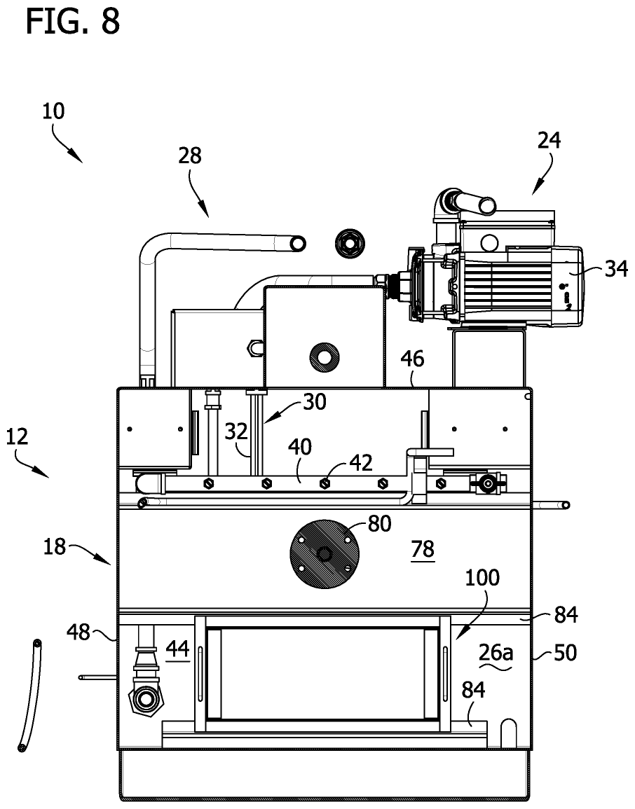

Still referring to FIGS. 1-12, the cabinet 12 of the washer 10 includes a part support platform 76 disposed in the upper portion 26b of the interior 26 of the housing 18. The support platform 76 comprises a wheel having an upward facing part support surface configured to receive one or more parts thereon to be cleaned by the washer 10. The washing system 24 is configured to wash the parts on the support platform 76. The support platform 76 may be perforated to allow washing fluid to flow through the support platform and into the lower portion 26a of the interior 26. Desirably, the support platform 76 is rotatably mounted such that the support platform is a turntable and is able to spin or rotate as the washer 10 is washing the parts on the support platform. The support platform 76 is mounted on a beam 78 extending through the interior 26 between the left and right side walls 48, 50. A connector 80 (FIG. 8) is supported by the beam 78 and connects to the support platform 76. The connector 80 defines a generally vertical axis of rotation about which the platform 76 rotates. A drive system 81 for turning the platform 76 includes a motor 81A operated by the control system and a drive gear 81B in mesh with teeth extending around the periphery of the platform 76. The motor 81A rotates the drive gear 81B, which causes the platform 76 (turn table) to rotate about its axis of rotation.

For reasons that will become apparent, desirably, the support platform 76 is movably disposed within the interior 26 of the housing 18. Specifically, the support platform 76 may be movable from an initial or cleaning position, where the support platform is arranged to support parts as the parts are cleaned (e.g., the location shown in FIGS. 1-7), to a secondary position that is spaced apart from the initial position. This secondary position may be within the interior 26 or outside the interior. For example, the support platform 76 may be removably connected or mounted to the housing 18 (specifically, the connector 80) such that the support platform can be removed from the interior 26 by an operator. The support platform 76 includes one or more handles 82 to be grasped by the operator to move the support platform from the cleaning position. In one embodiment, the support platform 76 is releasably coupled to the connector 80. For example, the support platform 76 may include a connector receiving portion (broadly, a female connector) configured to mate with (e.g., receive) the connector 80 (broadly, a male connector) when the support platform is lowered into the cleaning position. Accordingly, an operator may simply lift the support platform 76 to move the support platform to the secondary position (e.g., separate the connector 80 from the connector receiving portion). In the illustrated embodiment, the connector 80 is a cylinder and the connector receiving portion is a cylindrical wall that slides over the connector. Other configurations are within the scope of the present disclosure. The connector 80 may define a central opening that receives a projection, such as a shaft, of the connector receiving portion to further secure the connection between the support platform 76 and the connector. As described in more detail below, the support platform 76 is movable (e.g., between the cleaning and secondary positions) in order to provide access to a soak basket 100. It is understood the support platform 76 does not need to be removed from the housing 18 but that simply moving the support platform 76 to another location in the housing may be sufficient. Other ways of connecting the support platform 76 to the housing 18 are within the scope of the present disclosure.

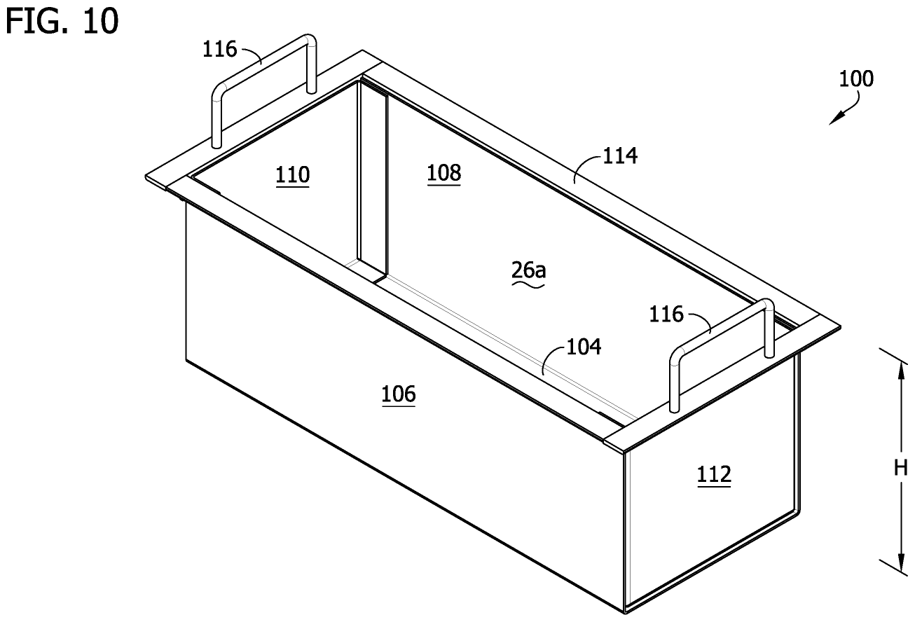

Desirably, the washer 10 includes a soak basket 100 (FIG. 10). The soak basket 100 is sized and shaped to receive one or more of the parts therein. The soak basket 100 is disposed in the reservoir 26a of the interior 26 of the housing 18 such that at least a portion of the soak basket is disposed within the washing fluid for soaking the one or more parts received in the soak basket in the washing fluid. In other words, when the washing fluid reservoir is filled with the washing fluid, a lower end of the soak basket is disposed below the surface of the washing fluid for soaking the one or more parts received in the soak basket in the washing fluid (e.g., a portion of the soak basket is disposed below the washing fluid fill level). In the illustrated embodiment, when the soak basket 100 is disposed in the reservoir 26a of the interior 26, the lower end of the soak basket is at or below a horizontal plane that is parallel to the bottom wall 44 and extends through a top of the strainer 38 and/or top of the circulation inlet (e.g., washing fluid inlet). As shown in FIG. 10, the soak basket 100 defines a soak basket interior 102 configured to receive one or more parts therein. The soak basket 100 has a bottom wall 104, opposite front and rear walls 106 and 108, respectively, extending upward from the bottom wall, and opposite left and right side walls 110 and 112, respectively, extending upward from the bottom wall and between the front and rear walls. Desirably, at least one of (if not all) of the bottom, front, rear, left side, and right side walls 104, 105, 108, 110, 112 are perforated to permit washing fluid to flow there-through. The bottom wall 104 defines a generally upward facing part support surface on which parts are supported when received in the basket interior. The soak basket 100 has an open top that provides access to the interior 102.

The soak basket 100 is configured to be movably (such as removably) disposed in the lower portion 26a of the interior 26. A peripheral flange 114 extends outward from each of the front, rear, left side and right side walls 106, 108, 110, 112 (specifically, upper edge margins thereof). When soak basket 100 is disposed in the lower portion 26a of the interior 26, the flange 114 (specifically, front and rear portions thereof) engages shoulders of rails 84 of the housing to support and position the soak basket in the interior. The rails 84 are spaced apart and extend through the interior 26, and the soak basket 100 is configured to be inserted between the rails. The soak basket 100 includes two handles 116 to be grasped by an operator to remove the soak basket from the interior 26 or place the soak basket in the interior 26 of the housing 18. When the soak basket 100 is in its installed position, the part support surface defined by the bottom wall 104 is below the high and low washing fluid levels 27, 29 of the reservoir. Accordingly, parts held in the interior of the basket 100 are below the washing fluid level and thus soak in the pool of washing fluid. In the illustrated embodiment, the high washing fluid fill level 27 corresponds to the upper end of the soak basket (e.g., the flange 114) such that substantially all of the basket is disposed below the surface of the washing fluid. Even if the washing fluid level is below the high washing fluid fill level 27 (e.g., at the low washing fluid fill level 29), the parts in the basket will soak in the washing fluid. The soak basket interior has a height H (FIG. 10) extending between the bottom wall 104 and the open top of the basket. Desirably, the majority of the height (e.g., at least 60%, at least 70%, more desirably at least 75% and even more desirably at least 80% or 90%) of the interior of the basket is below the high washing fluid level 27 when the basket is positioned in the reservoir 26a to provide room for parts to soak in the pool of washing fluid. Moreover, desirably at least 20%, at least 30%, at least 40%, more desirably at least 50%, or even more desirably at least 60% or 70% of the interior of the basket is below the low washing fluid level 29 when the basket is positioned in the reservoir 26a. In the illustrated embodiment, the low washing fluid fill level is located about midway along the height of the interior of the basket 100. Other arrangements can be used without departing from the scope of the present disclosure.

Referring to FIG. 7, in the illustrated embodiment, when the soak basket 100 and support platform 76 are disposed in the interior 26, at least a portion of the soak basket is disposed below at least a portion of the support platform. More specifically, the soak basket 100 is disposed below the part support surface of the part support platform 76. In the illustrated embodiment, the soak basket 100 is beneath the part support platform 76 such that the support platform at least partially blocks or inhibits access (e.g., manual access) to the soak basket 100 when the soak basket is disposed in the lower portion 26a of the interior 26 and the support platform is in the cleaning position. For example, as shown in FIG. 7, the support platform 76 extends generally from (e.g., adjacent to) the rear wall 46 to the front wall 62 of the door 20. In other words, the support platform 76 extends over most of the depth (e.g., at least 60%, at least 70%, more desirably at least 75% and even more desirably at least 80% or 90%) of the interior 26. More broadly, the support platform 76 extends over a majority of the horizontal cross-sectional area (e.g., at least 50%, at least 60%, at least 70%, more desirably at least 75% and even more desirably at least 80% or 90%) of the interior 26. Accordingly, in order to access the soak basket 100 and/or be able to remove the soak basket from the interior 26 or insert the soak basket in the interior, the support platform 76 is moved from the cleaning position, as described herein. By moving the support platform 76, enough space is created to allow the operator to freely access the soak basket 100 to place parts in the soak basket, remove parts from the soak basket, and/or install or remove the soak basket. In the illustrated embodiment, the soak basket 100 is disposed next to or near the front opening 52 when the soak basket is supported by the housing 12 to provide easy access to the soak basket through the front opening.

Different methods of using the washer 10 will now be described. In one method of use, one or more parts to be cleaned are inserted into the soak basket 100 in the lower portion 26a of the interior 26 such that the parts contained within the soak basket are disposed in pooled washing fluid in the washer for soaking in the washing fluid. For example, in one method of use, an operator may move the support platform 76 from the cleaning position to the secondary position, remove the soak basket 100 from the housing 18, place one or more parts to be soaked or cleaned in the interior 102 of the soak basket 18, move (e.g., replace) the soak basket back into the lower portion 26a of the interior to soak the one or more parts. Alternatively, the parts may be positioned in the soak basket 18 without removing the soak basket from the washer. The operator may allow the parts to soak in the soak basket in the pooled washing fluid for any period of time, such as an hour, six hours, or overnight. Prior to, after, or while placing the parts in the soak basket in the washer, the washing fluid can be added to the washer, and/or the washing fluid can be heated. Desirably, the parts in the soak basket 18 soak in warm or hot washing fluid to assist in loosening debris from the parts and cleaning the parts. For example, the heat source can be operated for a time to heat the washing fluid before and/or while the parts are soaking in the washing fluid. In one example, the heat source is operated periodically (e.g., overnight) to continue to heat the washing fluid while the parts are soaking in the washing fluid.

In another method of use, the operator can, while one or more parts in the soak basket 100 are soaking, run the washing system 24. For example, in one method of use, the operator may, after inserting the soak basket 100 filled with parts into the lower portion 26a of the interior 26, place one or more parts on the support platform 76 (after the support platform is moved back into the cleaning position), close the door 20 (e.g., move the door from the open position to the closed position), and run the washing system 24 to clean the parts on the support platform (which may or may not be rotating while the washing system is cleaning the parts). Thus, parts held in the soak basket 100 may be soaking while parts on the support platform 76 are being cleaned (e.g., sprayed with the heated washing fluid). In this manner of operation, as the washing fluid is moved by the washing fluid circulation system 28, a portion of the washing fluid may flow into and through the soak basket 100 to further clean and soak the parts contained therein. For example, parts may be moved in sequence to the soak basket 18 for a first washing cycle and then to the platform 76 for the second or later washing cycle.

In another method of use, the soak basket 100 is placed on the support platform 76. For example, before or after the parts in the soak basket 100 have soaked for a desired soak time (e.g., period of time), the soak basket can be moved from the lower portion 26a of the interior 26 and placed on the support platform 76. The washing system 24 can then be run to clean the parts in the soak basket 100. In particular, the washing system 24 will spray the parts in the soak basket 100 with washing fluid as the support platform 76 rotates the soak basket. It is understood that the particular order of the operational steps and processes of the washer 10 described herein are illustrative, and that the steps and processes described herein can be combined in any order.

Modifications and variations of the disclosed embodiments are possible without departing from the scope of the invention defined in the appended claims. For example, where specific dimensions are given, it will be understood that they are exemplary only and other dimensions are possible.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A parts washer for washing parts, the parts washer comprising:
a housing defining an interior configured to receive the parts therein, the interior including a washing fluid reservoir configured to hold a washing fluid, the washing fluid reservoir having a washing fluid fill level;
a soak basket sized and shaped to receive one or more of the parts, the soak basket disposed in the washing fluid reservoir such that at least a portion of the soak basket is disposed below the washing fluid fill level for soaking the one or more parts received in the soak basket in the washing fluid when the reservoir is filled with washing fluid at least up to the washing fluid fill level;
a part support platform in the interior of the housing, the part support platform having a part support surface configured to receive one or more of the parts thereon, the part support surface being above the washing fluid fill level; and
a washing system configured to wash the one or more parts on the part support surface.

2. The washer of claim 1, wherein the soak basket is removably disposed in the washing fluid reservoir.

3. The washer of claim 1, further comprising a washing fluid fill level indicator configured to indicate whether a level of washing fluid in the washing fluid reservoir corresponds to the washing fluid fill level, the bottom of the soak basket being below the washing fluid fill level.

4. The washer of claim 3, wherein the washing fluid fill level is a low washing fluid fill level and the washing fluid fill level indicator is configured to signal whether a level of washing fluid in the washing fluid reservoir is below the low washing fluid fill level.

5. The washer of claim 1, further comprising a washing system including a pump configured to circulate the washing fluid in the interior and a washing fluid inlet leading to the pump for permitting washing fluid to flow into the pump, the washing fluid inlet disposed below the washing fluid fill level.

6. The washer of claim 1, wherein at least a portion of the soak basket is disposed below the part support surface of the part support platform when the part support platform and soak basket are disposed in the interior.

7. The washer of claim 1, wherein the washing system is configured to circulate the washing fluid through the interior of the housing such that at least a portion of the washing fluid flows into the soak basket as the fluid is circulated by the washing system.

8. The washer of claim 1, wherein the part support platform is movable between a cleaning position where the part support platform is arranged in the interior to support the one or more parts on the part support surface as the one or more parts are being washed and a secondary position spaced apart from the washing position.

9. The washer of claim 8, wherein the secondary position is outside the interior.

10. The washer of claim 8, wherein the part support platform inhibits access to the soak basket when the part support platform is in the cleaning position.

11. The washer of claim 10, wherein the part support platform does not inhibit access to the soak basket when the part support platform is in the secondary position.

12. The washer of claim 1, wherein the part support platform is removably disposed in the interior.

13. The washer of claim 1, wherein the soak basket is at least partially perforated to permit the washing fluid to flow into and out of the soak basket.

14. A method of cleaning a part, the method comprising:
positioning a part to be cleaned in a soak basket in pooled washing fluid in a washing fluid reservoir of a parts washer;
permitting the part in the pooled washing fluid to soak in the pooled washing fluid;
before or after permitting the part to soak in the pooled washing fluid, supporting the part with a part support surface of a part support platform in the parts washer above the pooled washing fluid; and
washing the part while supported by the part support surface.

15. The method of claim 14, wherein supporting the part with the part support surface and washing the part while supported by the part support surface is performed after permitting the part to soak in the pooled washing fluid.

16. The method of claim 14, wherein supporting the part with the part support surface comprises moving the soak basket from the washing fluid reservoir and resting the soak basket on the part support surface.

17. The method of claim 14, wherein permitting the part in the pooled washing fluid to soak in the pooled washing fluid is performed while the part support platform is in the parts washer and the part support surface is above the part in the pooled washing fluid.

18. The method of claim 17, wherein the part is a first part and the method further comprises washing a second part supported by the part support platform while permitting the first part in the pooled washing fluid to soak in the pooled washing fluid.

19. The method of claim 18, wherein washing the second part supported by the part support platform further includes rotating the part support platform.

20. The method of claim 14, wherein positioning the part in the soak basket comprises moving the part support platform to provide access to the soak basket.
